(19) United States
(12) Patent Application Publication
(10) Pub. No.: US 2008/0153695 A1
(43) Pub. Date: Jun. 26, 2008

(54) Adsorbent Containing Alpha-1,4-Glucan and Process for Producing the Same

(76) Inventors: Kayo Hosoya, Hyogo (JP); Kazutoshi Fujii, Osaka (JP); Takeshi Takaha, Hyogo (JP); Takashi Kuriki, Osaka (JP); Junichi Takahara, Nara (JP); Michihiro Sunako, Nara (JP); Akitomo Terada, Nara (JP)

Correspondence Address: WENDEROTH, LIND & PONACK, L.L.P., 2033 K STREET N. W., SUITE 800, WASHINGTON, DC, 20006-1021, US

(21) Appl. No.: 11/883,765

(22) PCT Filed: Feb. 6, 2006
(86) PCT No.: PCT/JP06/02001

§ 371 Date: Sep. 14, 2007

(30) Foreign Application Priority Data
Feb. 7, 2005 (JP) 2005-030191

(51) Int. Cl. B01J 20/22; C08B 37/00

(52) U.S. Cl. 502/404; 536/123.12

(57) ABSTRACT

The present invention provides a composition for adsorbing or trapping an undesired material, wherein the composition comprises a functional α-1,4-glucan as an active ingredient. Specifically, α-1,4-glucan is allowed to be functionalized to provide said composition for adsorbing or trapping an undesired material. There are provided a composition comprising a functional α-1,4-glucan, all or a part of which is in a form of V-type crystal or an amorphous form, as well as an article comprising the composition as a functional material.

### TECHNICAL FIELD

The present invention relates to a composition for adsorbing an undesired material, wherein the composition comprises α-1,4-glucan as an active ingredient.

### BACKGROUND ART

One of cyclic α-1,4-glucans, cyclodextrin has cavities in its molecule wherein other molecule can be incorporated, i.e., inclusion, which is applied to various products such as pharmaceuticals, food and commodities. With respect to a linear α-1,4-glucan, it is also widely known that the linear α-1,4-glucan has a helical structure (i.e., helix structure) wherein other molecule can be incorporated, i.e., inclusion. Those skilled in the art expect adsorption or trap of an undesired material by the linear α-1,4-glucan. It has not been realized, however, to develop a product utilizing inclusion ability of α-1,4-glucan.

As a naturally occurring linear α-1,4-glucan, amylose in starch is well known. Even though the starch having a low amylose content is added to the desired composition in order to adsorb or trap an undesired material, the inclusion effect is not always asserted. It is necessary to increase the content of the linear α-1,4-glucan. Furthermore, there are still some problems in order to utilize the natural amylose as an adsorbent or a trapping agent for an undesired material, even if high linear α-1,4-glucan content is achieved.
(1) Generally, naturally occurring starch is a mixture of amylose, which content is about 20%, and amylopectin (a branched polymer containing branched amylose), which content is about 80%. Amylose itself can be separated or extracted from natural starch, but its process is complicated and yield of the amylose is very low. Therefore, it can not be an industrial process.
(2) Amylose present in the natural starch further has a small amount of branched structure. This structure would be different from helical structure formed by a fully linear amylose. Therefore, amylose in natural starch would lack potential to be asserted. The inclusion ability would be inferiorly estimated.
(3) Generally, amylose present in the natural starch has a broad molecular weight distribution (Mw/Mn) of greater than or equal to 1.3. It is known that amylose has various natures depending on its molecular weight. Natural amylose contains a lower molecular weight amylose and a higher molecular weight amylose, wherein the nature of the amylose having a lower molecular weight would antagonize that of the amylose having a higher molecular weight.
(4) It is difficult to provide a stable starch product, since natural starch contains amylose, which has inconstant quality depending on the species and growing conditions of the plant the starch comes from.

From the above-described aspects and the like, the natural amylose has not been employed as an adsorbent.

In contrast, there are some known synthetic methods wherein α-1,4-glucan can be enzymatically produced by linking glucose residues (enzymatic synthesis).

In an exemplified approach, it is proposed that sucrose is used as a substrate and treated with amylosucrase (EC 2.4.1.4), hereinafter which is called AMSU method. In AMSU method, however, the resulting α-1,4-glucan has low-degree of polymerization. It has been reported that even if highly purified amylosucrase is employed, the resulting α-1,4-glucan has a molecular weight of 8,941 Da (see FEBS Letters 471, Montalk et al, pages 219 to 223 (2000); Non-patent literature 1).

Even though α-1,4-glucan having a low distribution, i.e., a narrow molecular weight distribution, is obtained by AMSU method, the average molecular weight is low as described above. α-1,4-Glucan having a molecular weight of no more than several ten thousands Da has a much higher crystallinity and a lower inclusion ability.

As another enzymatic synthesis, a method using glucan phosphorylase α-glucan phosphorylase, EC 2.4.1.1: generally called phosphorylase) is proposed. This method includes a method comprising reacting phosphorylase itself with a substrate (glucose-1-phosphate) and transferring the glucosyl group to a primer (e.g., malto-heptaose), which is called as GP method. There is also a method comprising reacting sucrose phosphorylase (EC 2.4.1.7) in addition to phosphorylase with sucrose to synthesize G-1-P, and transferring a glucosyl group of the G-1-P to a primer, which is called as SP-GP method (see, for example, WO 02/097107 pamphlet (Patent literature 1)).

As another enzymatic synthesis, there is a method which comprises use of cellobiose phosphorylase (EC 2.4.1.20) in addition to the phosphorylase from cellobiose to produce G-1-P, wherein a glucosyl group in the resulting G-1-P is transferred to a primer (which is referred to as CBP-GP method) (see, for example, Japanese patent apln. no. 2003-415808 pamphlet (Patent literature 2)).

It is has been disclosed that α-1,4-glucan produced by the above-mentioned enzymatic synthesis has an inclusion ability. As similar to the fact that a starch containing amylose does not have a satisfactory inclusion ability, addition of the enzymatically synthesized α-1,4-glucan itself does not assert such function. On or prior to the filing of the present application, it was not disclosed nor suggested that use of amylose having a specific degree of polymerization provided different types of inclusion abilities under specific conditions.

Patent literature 1: WO 02/097107 pamphlet, pages 127 to 134;

Patent literature 2: Japanese patent apln. no. 2003-415808 pamphlet, pages 46 to 50;

Non-patent literature 1: FEBS Letters 471, Montalk et al, pages 219 to 223 (2000); and

Non-patent literature 2: Denpunkagaku no Jiten (Dictionary for Starch Sciences), Asakura Publishing Co., Ltd., Fuwa et al, pages 40 to 57 (2003).

### DISCLOSURE OF INVENTION

### Problems to be Solved by the Invention

The present invention is intended to solve the above-described problems, and to provide a composition for adsorbing an undesired material, wherein the composition comprises α-1,4-glucan as an active ingredient as well as a method for producing the same.

### Means for Solving Problems

The present inventors have studied α-1,4-glucan intensively on its inclusion ability to solve these problems and found, for the first time, that it is possible to adsorb or trap an undesired material by addition of a functional α-1,4-glucan. Specifically, it has been found that use of V-type crystal of α-1,4-glucan or amorphous α-1,4-glucan makes possible to adsorb or trap an undesired material.

The present invention relates to a composition for adsorbing or trapping an undesired material, wherein the composition comprises a functional α-1,4-glucan as an active ingredient. In one embodiment, the α-1,4-glucan may be enzymatically synthesized.

In one embodiment, the adsorbing or trapping may be caused by inclusion effect of the α-1,4-glucan.

In one embodiment, the functional α-1,4-glucan may be in a form of V-type crystal or an amorphous form.

In one embodiment, the functional α-1,4-glucan may be in a solution.

In one embodiment, the undesired material may be selected from the group consisting of a molecule in a gas, a molecule in a liquid, and a molecule to be attached on a solid surface.

In one embodiment, the undesired material may be selected from the group consisting of an environmental hormone, an odoriferous substance, a volatile organic substance, nicotine and/or tar, an allergen, a bacterium, a virus and an inorganic substance.

Another embodiment may be an article comprising the present composition as a functional material.

In one embodiment, the article may be used for a cigarette filter, an air-cleaning filter, a mask, a cleaning product, a fabric refresher, a hair care product, a personal cleaning product, a deodorant, a reodorant or a wipe.

### BRIEF DESCRIPTION OF DRAWINGS

FIG. 1 shows a diffraction pattern of B-type amylose which was found by powder X-ray diffractometry analysis.

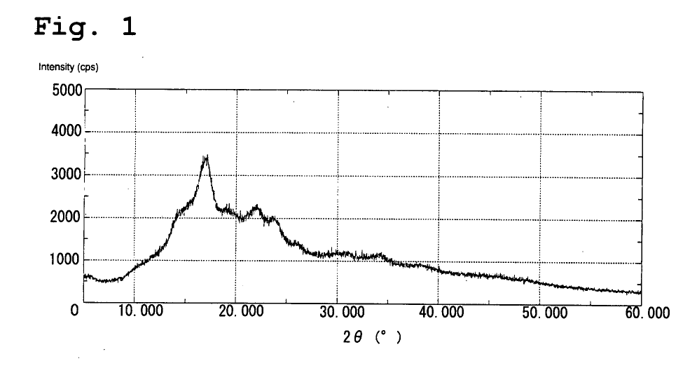

FIG. 2 shows a diffraction pattern of V-type amylose which was found by powder X-ray diffractometry analysis.

### BEST MODE FOR CARRYING OUT THE INVENTION

### Definition of Terms

### Composition

For example, the term “composition including/comprising/containing α-1,4-glucan” encompasses all compositions which have α-1,4-glucan. The present invention may be in a form of an aqueous solution of α-1,4-glucan or α-1,4-glucan itself.

### Adsorbent

The term “adsorbent”, as used herein, includes an agent in capable of adsorbing or trapping an undesired material, and a material containing such agent.

### Molecular Weight Distribution (Mw/Mn)

Polymer compound except specific polymer such as protein have a few range of molecular weight, whether it originates naturally or synthetically, not a single molecular weight. Therefore, a molecular weight distribution (Mw/Mn) of polymer compound is typically used for showing a degree of distribution of molecular weight in the field of polymer chemistry. The molecular weight distribution (Mw/Mn) is a rate of a weight-average molecular weight (Mw) based on a number average molecular weight (Mn). The molecular weight distribution is an index of a breadth of a range of molecular weights of a polymer compound. When a polymer compound has a completely single peak of a molecular weight, the ratio Mw/Mn is 1. When a polymer compound has a broader range of molecular weights, the ratio Mw/Mn is more than 1. The term “molecular weight”, as used herein, means “weight-average molecular weight” unless otherwise specified.

### α-1,4-Glucan

The term “α-1,4-glucan”, as used herein, refers to a polysaccharide having D-glucose as a constituting unit, which contains at least two saccharide units, each of which is linked via only one α-1,4-glucoside bond. α-1,4-Glucan is a linear molecule. α-1,4-Glucan refers to a linear glucan. A degree of polymerization refers to the number of saccharide units in one molecular of α-1,4-glucan. The term “degree of polymerization”, as used herein, means “weight-average degree of polymerization” unless otherwise specified. A weight-average degree of polymerization of α-1,4-glucan is calculated from dividing a weight-average molecular weight by 162.

### Crystal Form of α-1,4-glucan

α-1,4-Glucan includes three crystal forms, A, B and V-types. Different crystal forms are occurring, during extraction from natural starch and purification of the extract, depending on, some factors such as kinds of plants, extracting solvents and precipitants. A-type amylose is obtainable from cereal starch such as wheat and corm, B-type amylose is obtainable from potato starch such as potatoes and sweet potatoes, both of which contain the same double helix structure wherein the two α-1,4-glucan chains are parallel. Whereas, V-type amylose is obtainable from natural starch by addition of a precipitant such as ethanol or butanol, which has a single helix structure consisting of α-1,4-glucan chain. These three different crystal forms can be distinguished from each other by powder X-ray diffractometry. Differences between these crystal forms are described in detail in the non-patent literature 2.

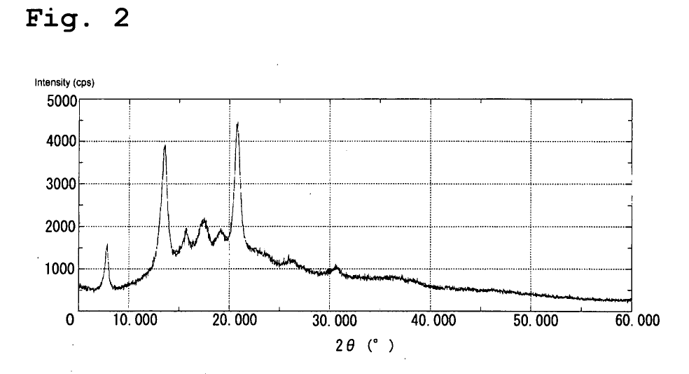

Briefly, “B-type amylose”, as used herein, has a pattern shown in FIG. 2 by powder X-ray diffractometry, and “V-type amylose”, as used herein, has a pattern shown in FIG. 3 by powder X-ray diffractometry.

### Functional α-1,4-glucan

The term “functional α-1,4-glucan”, as used herein, means that α-1,4-glucan is in a state which allows inclusion. Specifically, all or a part of α-1,4-glucan is in a form of V-type amylose or an amorphous form.

### Preparation of α-1,4-glucan

High molecular weight α-1,4-glucan, as used herein, can be prepared by a method known in the art, preferably prepared by a known enzymatic synthesis. An exemplified enzymatic synthesis includes a method using glucan phosphorylase. Phosphorylase is an enzyme which catalyzes phosphorolysis.

An example of the enzymatic synthesis using phosphorylase includes a method comprising a reaction of phosphorylase with a substrate: G-1-P to transfer a glucosyl group of G-1-P to a primer (e.g., malto-heptaose) (i.e., GP method). In the GP method, G-1-P as a starting material is expensive, and the GP method requires high-cost to produce α-1,4-glucan industrially. The GP method, however, has a significant advantage that a fully linear α-1,4-glucan includes obtainable due to sequential attachments of saccharide units each other via α-1,4-glycoside bonding. The GP method is known in the art.

Another example of the enzymatic synthesis using phosphorylase includes a method comprising a reaction of sucrose as a substrate, and malto-oligosaccharide, for example, as a primer with both sucrose phosphorylase and glucan phosphorylase in the presence of an inorganic acid, phosphoric acid, in order to enzymatically produce α-1,4-glucan, which method is called as SP-GP method. The SP-GP method can provide a fully linear α-1,4-glucan having an appropriately controlled molecular weight, which is similar to the GP method. In addition, the SP-GP method has an advantage that a low-cost production can be achieved by using less-expensive sucrose as a starting material. The SP-GP method is known in the art. SP-GP method as an effective production method is described, for example, in WO 02/097107 pamphlet.

Another example of the enzymatic synthesis using phosphorylase includes a method using cellobiose and malto-oligosaccharide, in which the cellobiose is a decomposed cellulose and is used as a substrate, and the malto-oligosaccharide is used as a primer. In the method, the cellobiose and the malto-oligosaccharide reacts with both cellobiose phosphorylase and glucan phosphorylase in the presence of an inorganic acid, phosphoric acid, in order to enzymatically produce α-1,4-glucan (i.e., CBP-GP method). The CBP-GP method can provide a fully linear α-1,4-glucan having an appropriately controlled molecular weight, which is similar to the GP method. The CBP-GP method is known in the art. CBP-GP method as an effective production method is described, for example, in Japanese patent apln. no. 2003-415808 pamphlet.

In contrast, the AMSU method described above is also a method for producing α-1,4-glucan by using an enzyme. The resulting α-1,4-glucan, however, has extremely low-degree of polymerization (less than about 9 kDa). Therefore, this method is not suitable for the present invention.

α-1,4-Glucan may consist of D-glucose. Alternatively, α-1,4-glucan may be a derivative thereof wherein modification is conducted, which does not adversely effect on the natures of the present composition. α-1,4-Glucan without any modification is preferable.

### Production of A- or B-Type Amylose and Production of V-Type Amylose

With respect to α-1,4-glucan, A-type amylose and B-type amylose can be converted to V-type amylose by precipitation with an organic solvent, etc. Specifically, A- or B-type amylose is subjected to heating or addition of an alkali to be dissolved at once, and then ethanol, n-butanol or the like is added thereto in order to precipitate amylose. The precipitate is collected and dried by an appropriate method, and the organic solvent can be removed to give amylose in a form of V-type crystal. Herein, the organic solvent to be added may be preferably a material which is to be included in amylose. More preferably, an organic solvent which is able to be evaporated and removed by a general drying method after formation of an inclusion compound may be used. An alcohol may be yet further preferable. Ethanol and butanol may be still more preferable.

Alternatively, in the above-described GP method, SP-GP method and CBP-GP method, B-type amylose and V-type amylose can be distinguished from each other and produced respectively depending on the reaction conditions and the purification conditions. Specifically, a reaction is allowed to proceed under conditions which can produce amylose having an average molecular weight of about 50,000, and then reaction mixture is allowed to be cooled to about 10° C. The resulting precipitate is B-type amylose. On the other hand, a reaction is allowed to proceed under conditions which can produce amylose having an average molecular weight of about 1,000,000, and then ethanol is added to the reaction mixture. The resulting precipitate is allowed to be dried to remove ethanol to give V-type amylose. Accordingly, B-type and V-type can be distinguished from each other and produced respectively depending on the reaction conditions and the precipitation method.

### Adsorbent

The adsorbent employed in the present invention includes a functional α-1,4-glucan. In order to adsorb or trap an undesired material in a gas, it may be preferable that all or a part of functional α-1,4-glucan consist of V-type amylose. It may be more preferable that all of functional α-1,4-glucan consist of V-type amylose. In order to adsorb or trap an undesired material in a solution, it may be preferable that all or a part of functional α-1,4-glucan consist of V-type amylose or an amorphous form. It may be more preferable that all of functional α-1,4-glucan consist of V-type amylose or an amorphous form. In order to adsorb or trap an undesired material to be attached on a solid surface, it may be preferable that all or a part of functional α-1,4-glucan consist of V-type amylose or an amorphous form. It may be more preferable that all of functional α-1,4-glucan consist of V-type amylose or an amorphous form. The B-type amylose can be employed in the present invention after conversion to the functional form thereof.

For example, the adsorbent employed in the present invention includes, but is not limited to, a cigarette filter, an air-cleaning filter, a mask, a cleaning product, a fabric refresher, a hair care product, a personal cleaning product, a deodorant, a reodorant, etc.

The material to be adsorbed or trapped in the adsorbent employed in the present invention includes, but is not limited to, an environmental hormone, an odoriferous substance, a volatile organic substance, nicotine and/or tar, an allergen, a bacterium, a virus, an inorganic substance, etc.

The adsorbent employed in the present invention can be formed into and used as a granule, a fiber, a fabric, a nonwoven fabric, a film, a cartridge, a filter, etc. It is also possible to use the functional amylose which is physically or chemically attached on a substrate, such as a fiber, so that the amylose functionally remains thereon.

According to the present invention, the adsorbent may include other component(s), which does/do not adversely affect on the present invention, in addition to the functional αa-1,4-glucan.

### EXAMPLES

The present invention is described in detail as the following Examples. The scope of the invention shall not be limited to the following Examples.

### (1) Preparation of α-1,4-glucan

4L of aqueous solution containing sucrose (3%), sucrose phosphorylase (1200 U/L), glucan phosphorylase (1200 U/L), inorganic phosphoric acid (30 mM), TETRUP H (an oligosaccharide syrup containing 70% maltotetraose, which is manufactured by HAYASHIBARA SHOJI, INC.) (600 μM) was subjected to an enzymatic reaction at 45° C. for 8 hours. The reaction was completed, and then the reaction mixture was cooled to 10° C. for 14 hours to precipitate amylose. The resulted precipitate was dried by a hot air dryer to give amylose (about 50 g). Thus obtained amylose has a molecular weight of about 50,000 and 1.02 of Mw/Mn. Powder X-ray diffractometry proved the amylose was B-type crystal. This amylose was used in the following Examples 1 and 2 as B-type amylose.

Distilled water (200 ml) was added to 10 g of powder of the above-prepared B-type amylose to give a suspension, and then the suspension was sealed and heated at 125° C. to give a solution. This solution was taken up when the temperature of the solution decreased to 100° C. Ethanol (200 ml) was added and mixed with the solution. The solution was left until the temperature of the solution decreased to the room temperature to give a precipitate. The resulted precipitate was subjected to centrifugation, collection and then lyophilization to give amylose (about 9 g). This amylose was used in the following Examples 1 and 2 as V-type 1 amylose.

Distilled water (200 ml) was added to 10 g of powder of the above-prepared B-type amylose to give a suspension. 5N sodium hydroxide (50 ml) was added to the suspension to give an amylose solution. Subsequently, 5N hydrochloric acid (50 ml) was added to neutralize the solution, and then ethanol (300 ml) was added to give a precipitate. The resulted precipitate was subjected to centrifugation, collection and then lyophilization to give amylose (about 9 g). This amylose was used in the following Examples 1 and 2 as V-type 2 amylose.

4 L of aqueous solution containing sucrose (6%), sucrose phosphorylase (1800 U/L), glucan phosphorylase (1800 U/L), inorganic phosphoric acid (30 mM), TETRUP H (manufactured by HAYASHIBARA SHOJI, INC.) (15 μM) was subjected to an enzymatic reaction at 45° C. for 16 hours. The reaction was completed, and then ethanol (2 L) was added and mixed, and the reaction system was left until the temperature of the mixture decreased to the room temperature to give a precipitate. The resulted precipitate was collected and re-suspended in distilled water (4 L). The suspension was subjected to a spray-drying. Finally, about 22 g of amylose was abtained. Thus obtained amylose has an average molecular weight of about 970,000 and 1.07 of Mw/Mn. Powder X-ray diffractometry proved the amylose was V-type crystal. This amylose was used in the following Examples 3 and 4 as a high molecular weight amylose.

### Example 1

### Interaction Between B-Type or V-Type Amylose and Iodine

Powder of B-type, V-type 1 or V-type 2 amylose was left for 30 minutes under the conditions saturation of iodine vapor was achieved at room temperature. As results, both of V-type 1 amylose and V-type 2 amylose were turned into purple colored powders. On the other hand, B-type amylose was a white powder as it was. Furthermore, V-type 1 amylose and V-type 2 amylose were gained in weight compared with the enzymatically synthesized B-type amylose. Accordingly, it was demonstrated that V-type amylose in a solid form had adsorbed and trapped iodine in a gaseous form.

### Example 2

### Interaction Between B-Type or V-Type Amylose and Formaldehyde

Powder of B-type, V-type 1 or V-type 2 amylose was left for 30 minutes under the conditions saturation of formaldehyde vapor was achieved at room temperature. As results, V-type 1 amylose and V-type 2 amylose were gained in weight. On the other hand, B-type amylose was not gained in weight. Accordingly, it was demonstrated that V-type amylose in a solid form had adsorbed and trapped formaldehyde in a gaseous form.

### Example 3

### Interaction Between High Molecular Weight Amylose or Soluble Starch and Nonylphenol

The high molecular weight amylose or soluble starch (available from Wako Pure Chemical Industries, Ltd.) was dissolved in distilled water to give 3 wt % of aqueous solution thereof. Nonylphenol (available from Wako Pure Chemical Industries, Ltd.) was added to the aqueous solution so that the final concentration was adjusted to 15%. The solution was stirred at 50° C. for 10 minutes. As results, the aqueous solution of the high molecular weight amylose gave a white suspension, and precipitate was obtained therefrom. On the other hand, the aqueous solution of the soluble starch remained the same as a non-colored transparent solution. Accordingly, it was suggested that the high molecular weight amylose interacted with nonylphenol.

### Example 4

### Interaction Between High Molecular Weight Amylose or Soluble Starch and Glycerol Monostearate

The high molecular weight amylose or soluble starch was dissolved in distilled water to give 3 wt % of aqueous solution thereof. Powder of glycerol monostearate (available from Wako Pure Chemical Industries, Ltd.) was added to the aqueous solution so that the final concentration was adjusted to 2%. The solution was heated and stirred at 70° C. for 10 minutes. As results, the aqueous solution of the high molecular weight amylose gave a white suspension, and precipitate was obtained therefrom. On the other hand, the aqueous solution of the soluble starch remained the same as a non-colored transparent solution. Accordingly, it was suggested that the high molecular weight amylose interacted with glycerol monostearate.

1. A composition for adsorbing or trapping an undesired material, wherein the composition comprises α-1,4-glucan.

2. The composition according to claim 1, wherein said α-1,4-glucan is enzymatically synthesized.

3. The composition according to claim 1, wherein said adsorbing or trapping is caused by inclusion effect of said α-1,4-glucan.

4. The composition according to claim 1, wherein said α-1,4-glucan is in a form of V-type crystal or an amorphous form.

5. The composition according to claim 1, wherein said α-1,4-glucan is in a solution.

6. The composition according to claim 1, wherein said undesired material is selected from the group consisting of a molecule in a gas, a molecule in a liquid, and a molecule to be attached on a solid surface.

7. The composition according to claim 1, wherein said undesired material is selected from the group consisting of an environmental hormone, an odoriferous substance, a volatile organic substance, nicotine and/or tar, an allergen, a bacterium, a virus and an inorganic substance.

8. An article comprising said composition according to claim 1 as a functional material.

9. The article according to claim 8, which is used for a cigarette filter, an air-cleaning filter, a mask, a cleaning product, a fabric refresher, a hair care product, a personal cleaning product, a deodorant, a reodorant or a wipe.
